(19) United States
(12) Patent Application Publication
(10) Pub. No.: US 2016/0141578 A1
(43) Pub. Date: May 19, 2016

(54) COMPOSITE SEPARATOR EQUIPPED IN BATTERY CELL AND METHOD FOR MANUFACTURING THE SAME

(71) Applicant: Hyundai Motor Company, Seoul (KR)

(72) Inventors: Sang Joon Lee, Anyang (KR); Byung Jo Jeong, Seoul (KR); Sa Heum Kim, Gwacheon (KR)

(21) Appl. No.: 14/752,956

(22) Filed: Jun. 28, 2015

(30) Foreign Application Priority Data
Nov. 13, 2014 (KR) 10-2014-0157929

(51) Int. Cl. H01M 2/16; H01M 2/14

(52) U.S. Cl. CPC H01M 2/1686; H01M 2/162; H01M 2/145

(57) ABSTRACT

The present invention provides a composite separator for a battery cell and a method for manufacturing the same. In particular, the composite separator equipped in a battery cell includes a non-woven separator comprising a high heat resistant polymer fiber that comprises a thermal deformation material on a high heat resistant polymer material. Accordingly, thermal contraction of the separator can be prevented in the high temperature condition which occurs when the battery cell is overcharged, and change of the shape of the separator can be prevented.

### CROSS-REFERENCE TO RELATED APPLICATION

This application is based on and claims the benefit of priority to Korean Patent Application No. 10-2014-0157929, filed on Nov. 13, 2014 in the Korean Intellectual Property Office, the disclosure of which is incorporated herein in its entirety by reference.

### TECHNICAL FIELD

The present invention relates to a composite separator for a battery cell and a method for manufacturing the same. In particular, the composite separator may be equipped in a battery cell to prevent an ignition and explosion risk which occurs when a lithium ion battery cell is overcharged and to provide secure safety feature to the lithium ion battery cell.

### BACKGROUND

A separator in a battery cell has been used to prevent ignition and explosion risks of a battery cell due to heat generation which occurs when a cathode and an anode contacts by cutting off a physical contact between the cathode and the anode.

The separator which has been applied to a conventional battery cell may be made of a polyethylene material. For example, since the polyethylene may melt in the high temperature condition when the battery cell is overcharged, pores of the separator may be closed and a current may be cut off, thereby preventing overcharging and secure safety of the battery cell.

However, when the polyethylene is melted, the pores may be closed but the separator may be thermally contracted. As a result, the cathode may contact the anode and thus further overcharging may occur, such that the ignition and explosion may occur due to the overcharging. This will be described below in more detail.

FIG. 1 illustrates existing conventional separator 1 made of a polyethylene material. The separator 1 of the polyethylene material has widely been used as commercial separator material, and the separator 1 may start to melt at a temperature of about 130° C. Since the pores of the separator 1 of the polyethylene material may be closed at elevated temperature, for example, of about 135° C., due to temperature increase in the battery cell during overcharging, the separator 1 may cuts off a current to prevent the overcharging. However, the separator 1 of the polyethylene material may be thermally contracted at high temperature, e.g. of about 135° C. or greater, and thus a shape of the separator 1 may be changed. In this case, the cathode may contact the anode and thus the cell may be ignited and exploded.

Recently, a product with improved thermal contraction by coating a surface of the separator 1 of the polyethylene material with ceramic has been developed. However, the thermal contraction of the separator 1 of the polyethylene material may not be completely controlled and thus the separator 1 of the polyethylene material may be contracted in the high temperature condition when the battery cell is overcharged, and thus, the shape of the separator 1 may be changed.

Meanwhile, a method for manufacturing an improved heat resistant polymer material in a thin fiber form using an electro-spinning method and molding it in a separator 2 form (see FIG. 2) has been reported. The heat resistant polymer material may be polyethylene terephthalate having a melting point of about 260° C. or greater. Therefore, the thermal contraction of the separator 2 may not occur in the high temperature condition during the overcharging of the battery cell. However, the pores may not be closed such condition due to the high heat resistance of the material. As a result, the current may not be suitably cut off when overcharging occurs and thus charging is continued to lead to the ignition, explosion, and the like of the cell.

The matters described as the related art have been provided only for assisting in the understanding for the background of the present invention and should not be considered as corresponding to the related art known to those skilled in the art.

### SUMMARY

In a preferred aspect, the present invention provides a composite separator for a battery cell to address the above-mentioned problems occurring in the related art.

In one aspect, the present invention provides a composite separator equipped in a battery cell and a method for manufacturing the same, thereby enhancing stability and safety features of the battery cell when the battery cell is overcharged. In particular, the composite separator may be provided as a composite material of a high heat resistant polymer material without a pore closing function and a thermal deformation material with a pore closing function.

According to an exemplary embodiment of the present invention, a composite separator for a battery cell may include: a non-woven separator comprising a heat resistant polymer fiber. In particular, the heat resistant polymer fiber may include a thermal deformation material on a heat resistant polymer material of the high heat resistant polymer fiber. For example, the thermal deformation material may be on coated or laminated on the high resistant polymer material.

The heat resistant polymer material may be, but limited to, polyethylene terephthalate.

The thermal deformation material may melt at a temperature of about 130° C. or greater. Exemplary thermal deformation material may be, but not limited to, polyethylene.

According to another exemplary embodiment of the present invention, a method for manufacturing a composite separator for a battery cell may include: preparing a heat resistant polymer fiber; processing the high heat resistant polymer fiber in a membrane form; preparing a coating solution by dissolving a thermal deformation material in a solvent; and dipping the heat resistant polymer fiber processed in a membrane form in the coating solution.

The heat resistant polymer fiber may be prepared by electro-spinning a heat resistant polymer material.

The method may further comprise: taking out the heat resistant polymer fiber from the coating solution and drying the heat resistant polymer fiber to evaporate the solvent.

The solvent used in the coating solution may be a polar solvent, and exemplary solvent may be, but not limited to, tetrahydrofuran.

An amount of the thermal deformation material included in the coating solution may suitably range, for example, from about 1 to about 50 wt % based on the total weight of the coating solution.

A temperature of the coating solution may range from about 25° C. to about 45° C.

Further provided is a batter cell that comprises the composite separator as described herein.

Other aspects of the invention are disclosed infra.

### BRIEF DESCRIPTION OF THE DRAWINGS

The above and other objects, features and advantages of the present invention will be more apparent from the following detailed description taken in conjunction with the accompanying drawings.

FIG. 1 is a microscopic view of a conventional separator of polyethylene in the related art;

FIG. 2 is a microscopic view of a conventional separator of high heat resistant polymer;

FIG. 3 shows an exemplary heat resistant polymer material included in a composite separator equipped in a battery cell according to an exemplary embodiment of the present invention and an illustrates main parts of an exemplary composite separator;

FIG. 4A illustrates a state before the composite separator of FIG. 3 is overcharged;

FIG. 4B illustrates a state after the composite separator of FIG. 3 is overcharged;

FIG. 5A is a cross-sectional view illustrating a state before the composite separator of FIG. 3 is overcharged;

FIG. 5B is a cross-sectional view illustrating a state after the composite separator of FIG. 3 is overcharged; and

FIG. 6 is a flow chart of a method for manufacturing a composite separator for a battery cell according to an exemplary embodiment of the present invention.

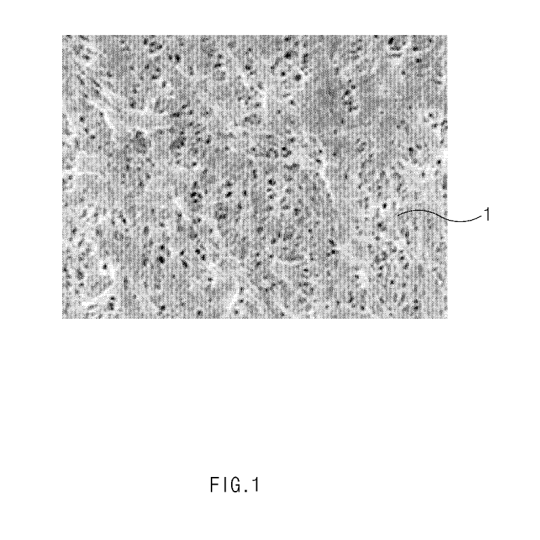

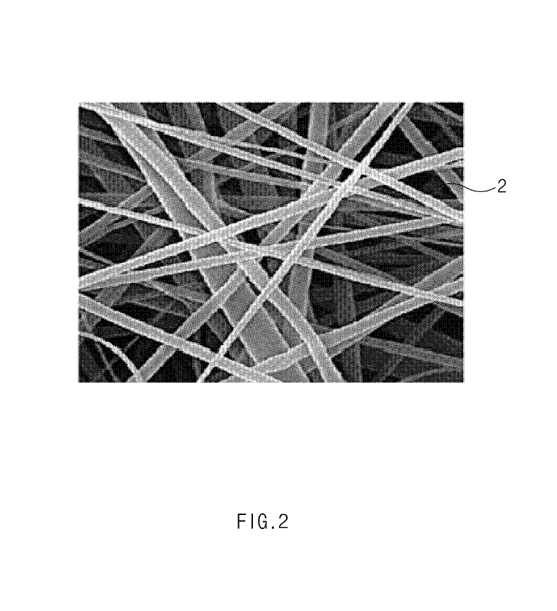

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Exemplary embodiments of the present invention will be described in detail with reference to the accompanying drawings.

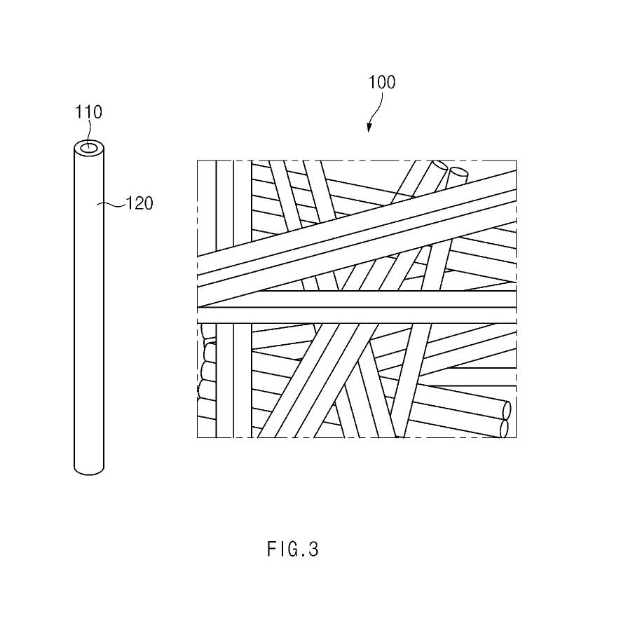

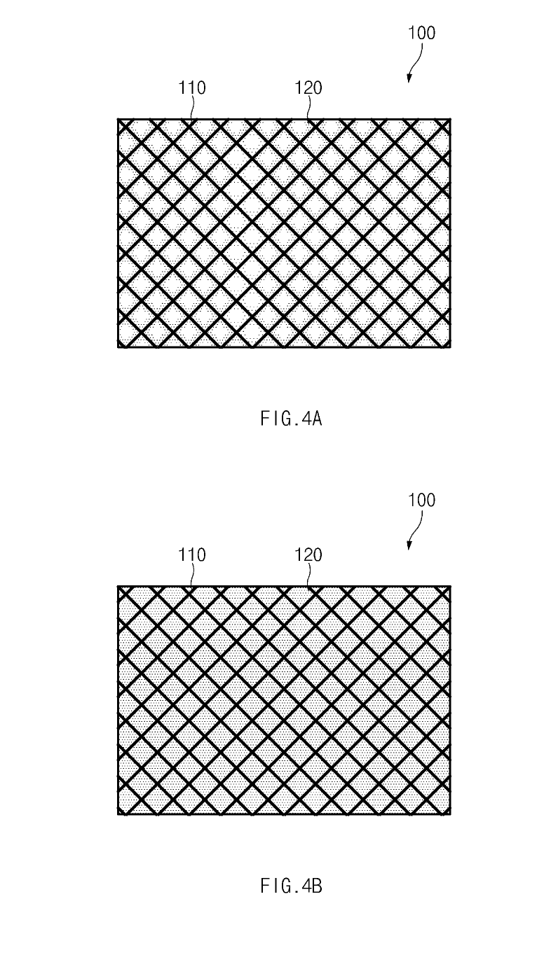

As illustrated in FIGS. 3 to 5B, a composite separator equipped in a battery cell according to an exemplary embodiment of the present invention may be a non-woven separator 100 that is formed of a heat resistant polymer fiber. In particular, the heat resistant polymer fiber may include a heat resistant polymer material 110 coated with a thermal deformation material 120.

Exemplary heat resistant polymer material 110 may be, but not limited to, polyethylene terephthalate. The thermal deformation material 120 may melt at a temperature of about 130° C. or greater, and exemplary thermal deformation material 120 may be, but not limited to, polyethylene.

As used herein, “thermal deformation” may refer to a physical or chemical change caused by increased internal temperature or heat. For example, the thermal deformation may be a physical or chemical change of a material that occurs after heat is applied or a temperature of the material is about 130° C. or greater. Further, the thermal deformation may cause changes in a physical or chemical structure or appearance of material. Exemplary thermal deformation may be melting, expansion, contraction, crack and the like. For example, the thermal deformation may cause melting of the thermal deformation material when the internal temperature thereof reaches about 130° C. or greater or when heat is applied to increase temperature of the material to about 130° C. or greater. In another example, the thermal deformation may not occur in the heat resistant polymer fiber even at a temperature of about 130° C. or greater. Further, in another case, the thermal deformation of the material may be a contraction when extra heat stress may be applied. For example, the thermal deformation such as contraction may occur to a non-heat resistant fiber when heat is applied.

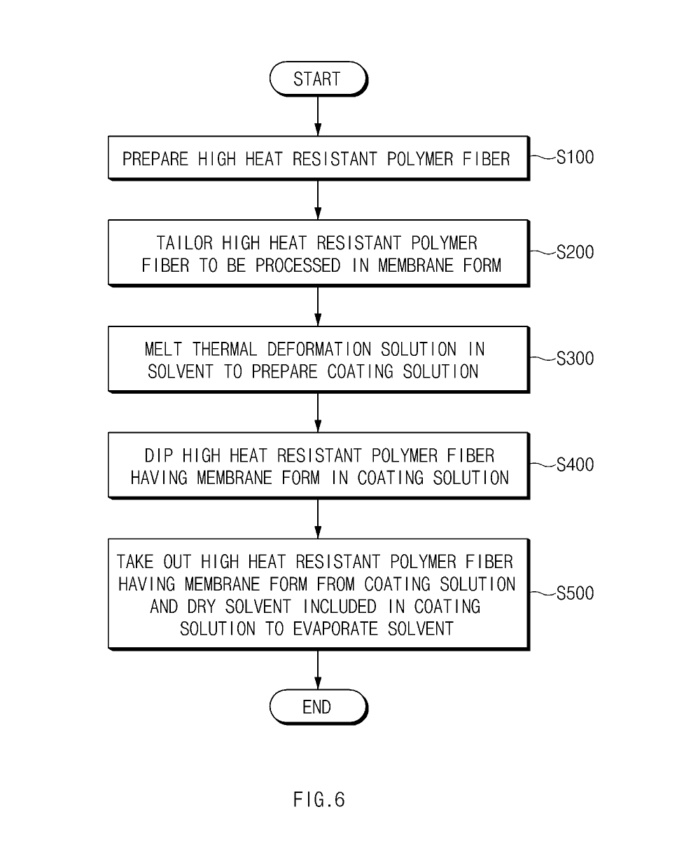

As illustrated in FIG. 6, according to an exemplary embodiment of the present invention, a method for manufacturing a composite separator equipped in a battery cell may include: preparing a heat resistant polymer fiber (S100); processing the heat resistant polymer fiber in a membrane form (S200); preparing a coating solution by dissolving the thermal deformation material 120 in a solvent (S300); and dipping the heat resistant polymer fiber processed in a membrane form in the coating solution (S400).

The “processing”, as used herein, may be tailoring or modifying a shape, size and structure of the material, e.g. heat resistant polymer fiber, to provide a suitable form, such as a membrane form.

In addition, the method for manufacturing a composite separator may further include: taking out the heat resistant polymer fiber from the coating solution; and drying the heat resistant polymer fiber to evaporate the solvent (S500).

The heat resistant polymer fiber may be prepared by electro-spinning the heat resistant polymer material 110. The coating solution may be prepared by dissolving the thermal deformation material 120 in the solvent, particularly, a polar solvent such as tetrahydrofuran.

The amount of the thermal deformation material 120 included in the coating solution may range from about 1 to about 50 wt %, based on the total weight of the coating solution. Further, a temperature of the coating solution of the thermal deformation material 120 may be maintained at about 25° C. to 45° C.

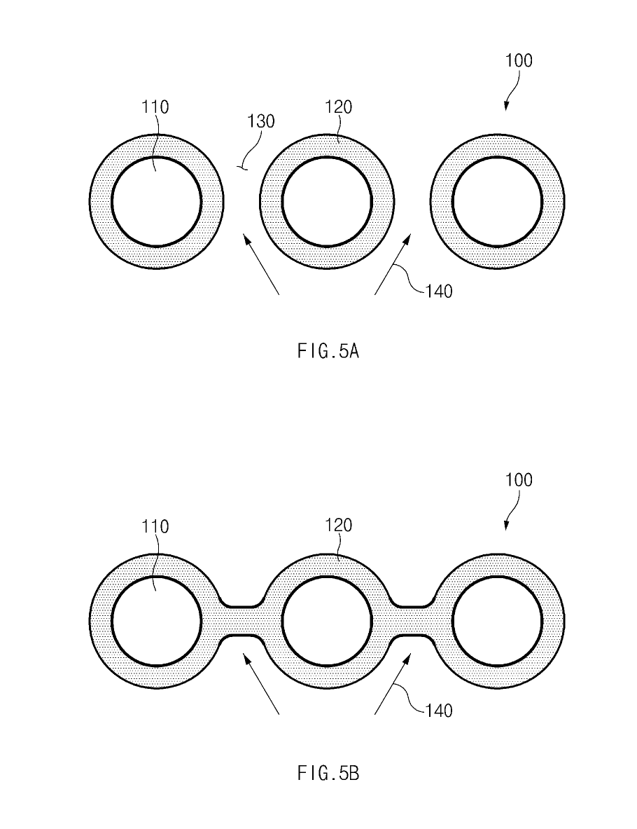

As illustrated in FIGS. 5A to 5B, in the composite separator according to the exemplary embodiment of the present invention as described above, although the battery cell is overcharged and the temperature of the battery cell rises to about 130° C. or greater due to an electrolyte decomposition reaction and the like at a high voltage, the heat resistant polymer material 110 in the composite separator may not melt or deformed and thus thermal deformation or contraction may not occur, such that the shape of the non-woven separator 100 may be maintained.

Moreover, since deformation or contraction of the non-woven separator 100 is suppressed due to the heat resistant polymer material, a short occurrence between a cathode and an anode may be prevented, such that the explosion of the cell may be prevented.

Meanwhile, the thermal deformation material 120 may be melted at about 130° C. or greater, and therefore pores 130 formed in the heat resistant polymer material 110 may be closed, such that an ion moving path 140 in the battery cell may be blocked.

When the ion moving path 140 is removed, a charging current may be cut off and thus the overcharging may not be continued and the temperature of the battery cell may not increase further and may start to drop.

As described above, according to exemplary embodiments of the present invention, the composite separator equipped in a battery cell and the method for manufacturing the same may suppress the separator from being thermally contracted in the high temperature condition when the battery cell is overcharged, and thus, change of the shape of the separator may be prevented.

Further, the pores of the separator may be closed in the high temperature condition during overcharging the current may be cut off to prevent further overcharging.

In the related art, when the battery cell is overcharged, overcharging and changes of the shape of the separator may not simultaneously prevented, but according to exemplary embodiments of the present invention, overcharging and changes of the shape of the separator may be simultaneously prevented even in the high temperature condition when overcharging occurs. As a result, secure safety features of the lithium ion battery cell may be obtained at the time of the overcharging.

Hereinabove, although the present invention has been described with reference to exemplary embodiments and the accompanying drawings, the present invention may not be limited thereto, but may be variously modified and altered by those skilled in the art to which the present invention pertains without departing from the spirit and scope of the present invention claimed in the following claims.

What is claimed is:

1. A composite separator for a battery cell, comprising:
a non-woven separator comprising a heat resistant polymer fiber,
wherein the heat resistant polymer fiber comprises a thermal deformation material on a heat resistant polymer material of the heat resistant polymer fiber.

2. The composite separator of claim 1, wherein the heat resistant polymer material is polyethylene terephthalate.

3. The composite separator of claim 1, wherein the thermal deformation material is polyethylene.

4. The composite separator of claim 1, wherein the thermal deformation material melts at a temperature of about 130° C. or greater.

5. A method for manufacturing a composite separator for a battery cell, comprising:
preparing a heat resistant polymer fiber;
processing the high heat resistant polymer fiber in a membrane form;
preparing a coating solution by dissolving a thermal deformation material in a solvent; and
dipping the high heat resistant polymer fiber processed in a membrane form in the coating solution.

6. The method according to claim 5, wherein the heat resistant polymer fiber is prepared by electro-spinning a heat resistant polymer material.

7. The method according to claim 5, further comprising:
taking out the heat resistant polymer fiber from the coating solution and drying the heat resistant polymer fiber to evaporate the solvent.

8. The method according to claim 5, wherein the solvent is a polar solvent.

9. The method according to claim 8, wherein the solvent is tetrahydrofuran.

10. The method according to claim 5, wherein a weight ratio of the thermal deformation material ranges from about 1 to about 50 wt % based on the total weight of the coating solution.

11. The method according to claim 5, wherein a temperature of the coating solution ranges from about 25° C. to about 45° C.

12. A battery cell that comprises a composite separator of claim 1.
